(19) United States
(12) Patent Application Publication
(10) Pub. No.: US 2025/0229384 A1
(43) Pub. Date: Jul. 17, 2025

(54) JEWELRY OPENING DEVICE AND METHOD OF OPENING A JEWELRY FASTENER

(71) Applicant: Edilberto Portilla, Margate, FL (US)

(72) Inventor: Edilberto Portilla, Margate, FL (US)

(21) Appl. No.: 18/975,828

(22) Filed: Dec. 10, 2024

Related U.S. Application Data
(60) Provisional application No. 63/620,540, filed on Jan. 12, 2024.

(51) Int. Cl. B25B 9/02; A47G 25/90

(52) U.S. Cl. CPC B25B 9/02; A47G 25/901

(57) ABSTRACT

There is provided a jewelry opening device that can open a jewelry fastener in a careful manner, and only to a desired extent. The jewelry opening device is such that it can maintain a jewelry fastener in an open position without having to maintain a hand grip on the device. Thus, a user can manipulate the jewelry fastener, by opening and then closing the jewelry fastener more easily, and without having to worry about maintaining a hand grip on the device. The device contains a unique biasing element which provides for a biasing of the elongate members of the device towards each other in a controlled and consistent manner such that it can be used for many differently sized jewelry fasteners.

### CROSS-REFERENCE TO RELATED APPLICATIONS

This application claims the benefit of U.S. Provisional Patent Application Ser. No. 63/620,540, filed on Jan. 12, 2024, which is incorporated by reference herein in its entirety.

### FIELD OF THE INVENTION

The present invention relates generally to the field of jewelry. More particularly, the present invention relates generally to the field of means of opening jewelry fasteners and/or connectors.

### BACKGROUND OF THE INVENTION

Jewelry is a very common means of self-adornment which is employed by both men and women. Often a piece of jewelry can enhance one's appearance and outfit and provide for both aesthetic beauty and value in terms of the precious metals used to make it.

However, some jewelry such as necklaces, anklets and bracelets frequently have connectors and/or fasteners that are difficult to grasp, easily retain in an open position and securely latch. Part of this problem is the fine delicate nature of many of these pieces of jewelry, but the jewelry latching process is further complicated by the limitations of the fastener and/or wearer to successfully manipulate and fasten the connectors of the piece of jewelry together.

For example, the fastening of a typical lobster claw or spring ring type clasp requires the manipulation of a small lever that extends from the annular ring of the clasp to actuate the opening and closing of the clasp. The lever can be difficult to find, manipulate and retain in an open position against the bias of the clasp visually or tactilely. Then one still has to place the opposing connector of the piece of jewelry into the narrow opening of the clasp and release the lever to fasten the connectors together.

This difficult process of fastening the clasp and opposing connector of a piece of jewelry can be increased by the inability of the person doing so to see, align and fasten the connectors of the jewelry together. Other factors that can complicate this process are long fingernails and disabilities such as poor eye sight and/or arthritis that increase the visual and/or manual strain of what should be a simple process.

This difficult jewelry fastening process reduces many wearers to attempt to latch the connectors by trial and error. This can be sufficiently frustrating and painful that in many instances when the fastener is also the wearer the person is compelled to seek additional assistance or stop wearing jewelry altogether. While a number of aids have been developed to assist the fastening of the connectors of pieces of jewelry, none provide the ease of use and flexibility that many fasteners demand.

Accordingly, there remains a need for a solution to at least one of the aforementioned problems. For instance, there is an established need for an aid for the fastening and unfastening of lobster claw and spring-ring type jewelry fasteners and connectors that can readily retain the fastener/connector in an open position to facilitate the fastening and unfastening of the connectors.

### SUMMARY OF THE INVENTION

The present invention can be directed to a jewelry opening device. The device can open and retain open a jewelry fastener such as a clasp. The jewelry opening device is such that it can maintain a jewelry fastener in an open position without having to maintain a hand grip on the device. Thus, a user can manipulate the jewelry fastener, by opening and then closing the jewelry fastener more easily, and without having to worry about maintaining a hand grip on the device. The device contains a unique biasing element which provides for a biasing of the elongate members of the device towards each other in a controlled and consistent manner such that it can be used for many differently sized jewelry fasteners.

The term “about” as used herein can entail a variance of 10% greater or lower than the value recited.

The term “comprising” as used herein also encompasses the terms “consisting essentially of” and “consisting of”.

The values of any endpoint(s) of any range(s) recited herein can be used to create different ranges or different endpoints of ranges to those described herein. The endpoints in any of the ranges described herein can also include any integer value in the recited range even if not expressly described. Thus, for example, a range of from 1.0 to 10 can include as alternate range endpoints any integer between 1 and 10, such as, the non-limiting integer examples of 2, 3, 4, 5, 6, 7, 8 and 9.

In a first implementation of the invention there can be provided a jewelry opening device comprising:
a first flat elongate member having a proximal end and an opposing distal end, and a substantially perpendicularly angled tip on the proximal end of the first flat elongate member facing in a first direction;
a second flat elongate member having a proximal end and an opposing distal end, and an obtusely angled forked tongue tip on the proximal end of the second flat elongate member facing in substantially a second direction, which is substantially opposite to the first direction;
a flat sliding longitudinal biasing member which comprises:
a flat portion which lies in plane over a planar surface of the first or second flat elongate member between the proximal and distal end thereof, and
a wrap-around portion which extends perpendicularly from the flat portion and encapsulates sides of the first and second flat elongate members and at least part of the planar surface of an opposing first or second flat elongate member which is not overlaid by the flat portion, and
wherein the biasing member is configured to bias the first and second flat elongate members towards each other in the first and second directions as the flat sliding longitudinal biasing member translates longitudinally in a direction from the distal ends towards the proximal ends of the first and second elongate members, and configured to continuously keep at least part of both of the distal ends in flush contact along planar surfaces of the first and second elongate members which are not contacted by the biasing member.

In one aspect of the invention, wherein the first flat elongate member and the second flat elongate member are longitudinally and/or laterally aligned with each other.

In another aspect of the invention, the first flat elongate member and the second flat elongate member each have a thickness of from 1/32 of an inch up to about 5/16 of an inch, preferably from about 1/16 of an inch up to about ¼ of an inch. It will be understood that the term “flat” as regards the first and second flat elongate members can include the noted thicknesses.

In yet another aspect of the invention, wherein the first and/or second flat elongate members have a grooved gripping area along at least portion of their planar surface.

In yet even another aspect of the invention, wherein the first and/or second flat elongate members each have a length of from about 2 inches up to about 6 inches, preferably from about 2.5 inches up to about 4.5 inches.

In yet one other aspect of the invention, wherein the first and second elongate members have the same tapering widths from the distal end to a border of the tips of the proximal ends and can preferably be from about ⅛ of an inch up to about h of an inch.

In another aspect of the invention, the elongate members can be made of a metal material, preferably a metal material selected from the group consisting of aluminum, steel, stainless steel, low carbon austenitic steel, chromium, nickel, molybdenum, and combinations thereof. More preferably, the elongate members can be made of low carbon austenitic steel which contains chromium and has nickel and molybdenum as additional alloying elements.

In yet even one other aspect of the invention the expression “substantially perpendicularly angled” as regards the tip of the first flat elongate member is described as having an angle deviating from 90 degrees of more or less than 10 degrees therefrom, with the understanding that the angle is the angle between the planar surface of the first flat elongate member and the planar surface of the first flat elongate member.

In yet still one other aspect of the invention, the proximal and distal ends of the elongate members are opposite longitudinal ends thereof.

In another embodiment herein the expression “obtusely angled” as regards the obtusely angled forked tongue tip can comprise an angle of greater than 90 degrees and less than 180 degrees, preferably from about 100 degrees to about 170 degrees, preferably from about 110 degrees to about 160 degrees and most preferably from about 115 degrees to about 150 degrees.

In yet still even another aspect of the invention, the expression “substantially opposite” will be understood as regards the obtusely angled forked tip of the proximal end of the second flat elongate member relative to the substantially perpendicularly angled tip of the proximal end of the first elongate member, or alternatively wherein the angle of the obtusely angled forked tip and the substantially perpendicularly angled tip are within a difference in degrees of no more than 45 degrees from each other, preferably no more than about 30 degrees from each other in terms of their respective angles. In another embodiment, the expression “substantially opposite” can be directly opposite to each other, or within 5 degrees of each other.

In another aspect of the invention, the thickness of the flat sliding longitudinal biasing member can have a thickness in both its flat portion and its wrap around portion which falls within the thickness described herein for the elongate members.

In yet another aspect of the invention, the flat sliding longitudinal biasing member can have a length less than that of the elongate members, preferably from about 1 inch to about 3 inches, preferably from about 1.5 inches to about 2.5 inches. The flat sliding longitudinal biasing member can have a uniform width or a tapered width which corresponds to the width of the elongate members described herein. The flat sliding longitudinal biasing member can be made of the same or different selection of materials set out herein for the elongate members.

In yet another aspect of the invention, the flat sliding longitudinal biasing member can further comprise an elevated gripping element on a planar surface of the flat portion, preferably the elevated gripping element can be dome-shaped, preferably dome-shaped with grooves thereon, and most preferably wherein the elevated gripping element is made of an elastomeric material, such as, but not limited to natural rubber, synthetic rubber, ethylene rubber, ethylene propylene rubber, EPDM rubber, polyisoprene rubber, butyl rubber, acrylonitrile butadiene rubber, silicone rubber, polyurethane, cork, and combinations thereof. In one embodiment the elevated gripping element can wrap around the flat portion of the flat sliding longitudinal biasing member in part or entirely, or alternatively, the elevated gripping element can have the flat portion of the flat sliding longitudinal biasing member pass therethrough.

In yet even another aspect of the invention, the flat sliding longitudinal biasing member can have a stadium shaped aperture along the flat portion and a post which is oriented perpendicular to the flat portion of the flat sliding longitudinal biasing member, and which can pass through the aperture and make contact with the underlying elongate member. The contact made with the underlying elongate member can impart a displacement of the elongate member and the flat portion of the flat sliding longitudinal biasing member away from each other to a small amount such as from about 1/16 of an inch up to about ¼ of an inch. Such displacement can also work alone or in conjunction with the wrap-around portion as described herein to provide for the ability of the jewelry opening device to have the biasing remain between the elongate members, i.e., to be locked in place, upon removal of a hand grip therefrom. The stadium-shaped aperture can lie between the elevated gripping element and the wrap around portion of the biasing member, can be centrally located along the width of the flat portion and can have a length of ¾ of an inch to 1 inch less than the length of the biasing member.

In one embodiment herein the plane of the flat portion can be flush with the plane of the underlying first or second elongate member, alternatively, the plane of the flat portion can be such that it descends in a slight angle, e.g., from about 1 degree to about 10 degrees in relation to the plane of the underlying elongate member from an elevated gripping element end towards the opposing end of the flat portion, i.e., the portion contiguous the wrap-around portion of the flat sliding longitudinal biasing member.

In another embodiment, the entire flat sliding longitudinal biasing member can be moved along the elongate members, i.e., translated to the extent that the post is able to be retained in the stadium shaped aperture along the length thereof. Thus, the translation can be limited to the length of the aperture.

In yet another aspect of the invention, the encapsulation of the sides by the wrap around portion can make contact with the sides of the first and second elongate members and either partially or completely cover and/or make contact with the planar surface of the opposing first or second elongate member which is not covered by the flat portion.

In yet even another aspect of the invention, as noted above, the contact made with the underlying elongate member can impart a displacement of the elongate member and the flat portion of the flat sliding longitudinal biasing member away from each other to a small amount, and this feature can contribute to and/or be enhanced in terms of biasing the elongate members towards each other in the first and second directions by the translation movement of the biasing member for the length of the aperture, wherein the movement of sliding member from the direction of the distal ends towards the proximal ends facilitates a biasing of the elongate members together and vice-versa, a translation of the biasing member from the direction of the proximal ends to the direction of the distal ends facilitates a biasing of the elongate members away from each other. As noted above, the translation using the biasing member can lock the biased distance of the elongate members in such a position that a biasing pressure is not required to be kept in the opposing first and second directions by a user.

In a second implementation of the invention there can be provided herein a method of opening a jewelry fastener comprising:
providing a jewelry opening device comprising:
   a first flat elongate member having a proximal end and an opposing distal end, and a substantially perpendicularly angled tip on the proximal end of the first flat elongate member facing in a first direction;
   a second flat elongate member having a proximal end and an opposing distal end, and an obtusely angled forked tongue tip on the proximal end of the second flat elongate member facing in substantially a second direction, which is substantially opposite to the first direction;
   a flat sliding longitudinal biasing member which comprises:
      a flat portion which lies flush with a planar surface of the first or second flat elongate member between the proximal and distal end thereof, and
      a wrap-around portion which extends perpendicularly from the flat portion and encapsulates sides of the first and second flat elongate members and at least part of the planar surface of an opposing first or second flat elongate member which is not covered by the flat portion, and
      wherein the biasing member is configured to bias the first and second flat elongate members towards each other in the first and second directions as the flat sliding longitudinal biasing member translates longitudinally in a direction from the distal ends towards the proximal ends of the first and second elongate members and configured to continuously keep at least part of both of the distal ends in flush contact along planar surfaces of the first and second elongate members which are not contacted by the biasing member;
attaching the obtusely angled forked tongue tip on the proximal end of the second flat elongate member to a fixed position on a lower end of a jewelry clasp;
attaching the substantially perpendicularly angled tip on the proximal end of the first flat elongate member to a lever of the jewelry clasp;
translating the flat sliding longitudinal biasing member from the distal ends to towards the proximal ends of the first and second flat elongate members such that the first and second proximal ends of the flat elongate members are biased towards each other in the first and second directions to an extent that the lever is depressed, and the jewelry clasp is opened.

In one aspect of the invention, the above-noted attaching steps can be reversed in order.

In yet one other aspect after the providing step and prior to the translating step, the method can alternatively encompass the steps of:
attaching the substantially perpendicularly angled tip on the proximal end of the first flat elongate member to a fixed position on a lower end of a jewelry clasp; and,
attaching the obtusely angled forked tongue tip on the proximal end of the second flat elongate member to a lever of the jewelry clasp; and such steps can be conducted in either order. In another aspect of the invention, the above-noted attaching steps can be reversed in order.

In yet another aspect of the invention the translation can be accompanied by a squeezing of the elongate members towards each other in the first and second directions.

In a third implementation of the invention there can be provided herein a set of from two to about 6 different jewelry opening devices of different sizes, wherein each jewelry opening device comprises
a first flat elongate member having a proximal end and an opposing distal end, and a substantially perpendicularly angled tip on the proximal end of the first flat elongate member facing in a first direction;
a second flat elongate member having a proximal end and an opposing distal end, and an obtusely angled forked tongue tip on the proximal end of the second flat elongate member facing in substantially a second direction, which is substantially opposite to the first direction;
a flat sliding longitudinal biasing member which comprises:
   a flat portion which lies flush with a planar surface of the first or second flat elongate member between the proximal and distal end thereof, and
   a wrap-around portion which extends perpendicularly from the flat portion and encapsulates sides of the first and second flat elongate members and at least part of the planar surface of an opposing first or second flat elongate member which is not covered by the flat portion, and
   wherein the biasing member is configured to bias the first and second flat elongate members towards each other in the first and second directions as the flat sliding longitudinal biasing member translates longitudinally in a direction from the distal ends towards the proximal ends of the first and second elongate members, and configured to continuously keep at least part of both of the distal ends in flush contact along planar surfaces of the first and second elongate members which are not contacted by the biasing member.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 illustrates a lower view of the jewelry opening device of the present invention;

FIG. 2 illustrates an exploded view of the jewelry opening device of FIG. 1 of the present invention;

FIG. 3 illustrates a top perspective view of the jewelry opening device of FIG. 1 in its most open position;

FIG. 4 illustrates the jewelry opening device of FIG. 3 attached to a jewelry fastener prior to the jewelry fastener being opened with the jewelry opening device;

FIG. 5 illustrates a top perspective view of the jewelry opening device of FIG. 1 in its most closed position;

FIG. 6 illustrates the jewelry opening device of FIG. 5 attached to a jewelry fastener after the jewelry fastener is opened with the jewelry opening device; and,

FIG. 7 illustrates the jewelry opening device of FIG. 1 attached to a jewelry fastener after the jewelry fastener is opened with the jewelry opening device.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

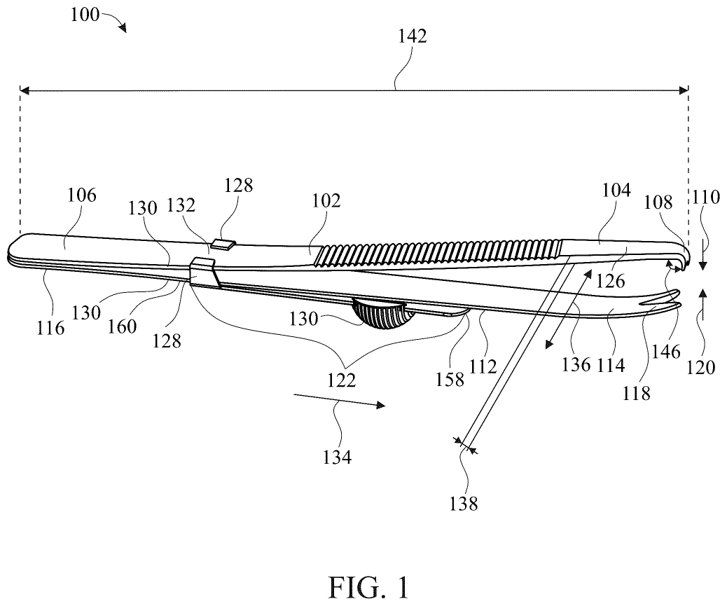

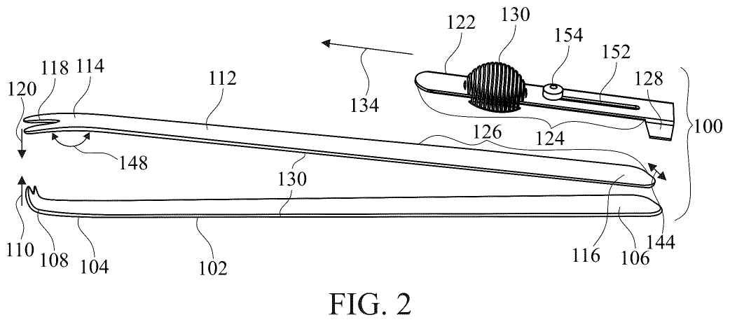

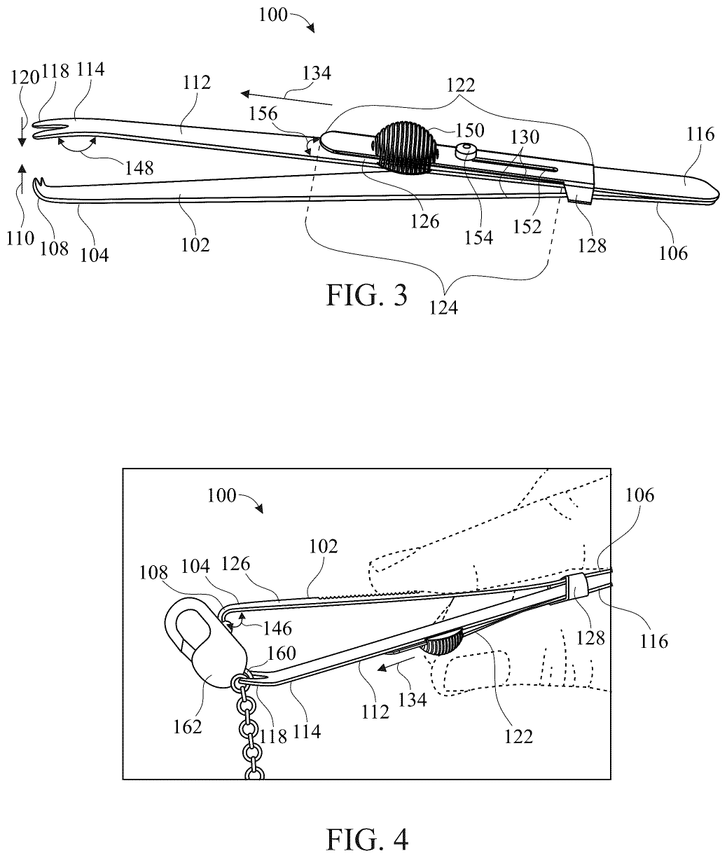

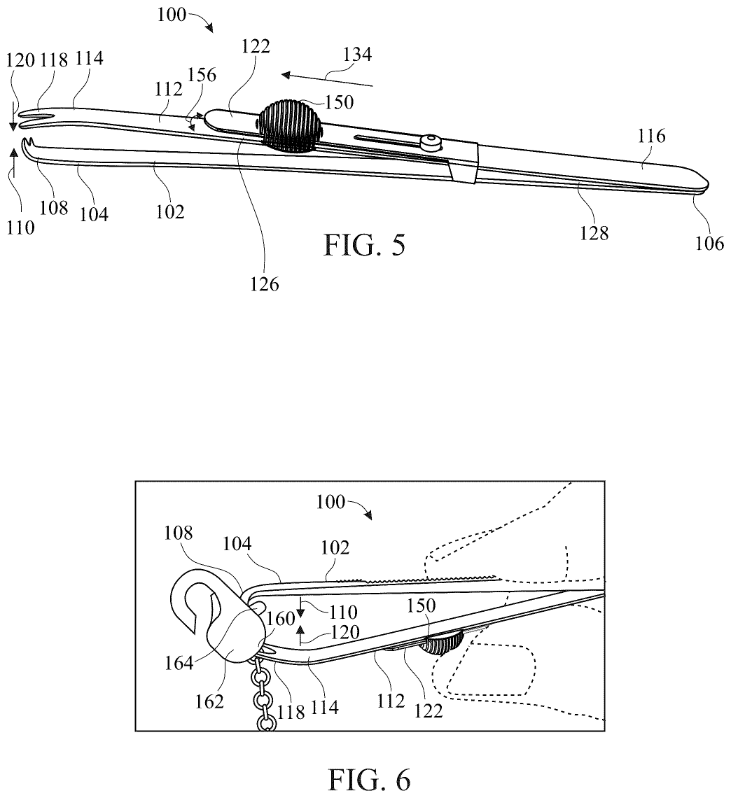

Referring initially to FIGS. 1-7, there is provided a jewelry opening device 100 which contains a first flat elongate member 102 having a proximal end 104 and an opposing distal end 106 and substantially perpendicularly angled tip 108 on the proximal end 104 of the first flat elongate member 102 facing in a first direction see arrow 110. The second flat elongate member 112 has a proximal end 114 and an opposing distal end 116 and an obtusely angled forked tongue tip 118 on the proximal end 114 of the second flat elongate member 112 facing in substantially a second direction, see arrow 120, which is in substantially opposite the first direction 110.

Still referring to FIGS. 1-7, there is provided a flat sliding longitudinal biasing member 122 which contains a flat portion 124 which lies in plane over a planar surface 126 of the second flat elongate member 112 between the proximal 114 and distal end 116 thereof, and a wrap-around portion 128 which extends perpendicularly from the flat portion 124 and encapsulates sides 130 of the first 102 and second 112 flat elongate members and at least part of the planar surface 132 of an opposing first elongate member 102 which is not overlaid by the flat portion 124.

Still referring to FIGS. 1-7, the biasing member 122 is configured to bias the first 102 and second 112 flat elongate members towards each other in the first 110 and second 120 directions as the flat sliding longitudinal biasing member 122 translates longitudinally in a direction 134 from the distal ends 106/116 towards the proximal ends 104/114 of the first 102 and second 112 elongate members, and configured to continuously keep at least part of both of the distal ends 106/116 in flush contact along planar surfaces 132/126 of the first 102 and second 112 elongate members which are not contacted by the biasing member 122.

The first flat elongate member 102 and the second flat elongate member 112 are longitudinally 134 and/or laterally 136 aligned with each other. The first flat elongate member 102 and the second flat elongate member 112 each have a thickness 138 and the first flat elongate member can have a grooved gripping area 140 along at least portion of the planar surface 132. The first 102 and/or second 112 flat elongate members each have a length 142 and can have widths 144 from the distal end 106/116 to a border of the tips 108/118 of the proximal ends 104/114.

The substantially perpendicularly angled tip 108 of the first flat elongate member 102 has an angle 146 between the planar surface 126 of the first flat elongate member 102 and the planar surface of the first flat elongate member. The proximal 104/114 and distal ends 106/116 of the elongate members 102/112 are opposite longitudinal ends thereof. In addition, there is provided an obtuse angle 148 of the obtusely angled forked tongue tip 118.

The flat sliding longitudinal biasing member 122 can have a length less than that of the elongate members 102/112 and a uniform width or a tapered width which corresponds to the width 144 of the elongate members 102/112 described herein and can further comprise an elevated gripping element 150 on the planar surface 126 of the flat portion 124, and preferably the elevated gripping element 150 can wrap around the flat portion 124 of the flat sliding longitudinal biasing 122 member in part or entirely. The flat sliding longitudinal biasing member 122 can have a stadium shaped aperture 152 along the flat portion 124 and a post 152 which is oriented perpendicular to the flat portion 124 of the flat sliding longitudinal biasing member 122, and which can pass through the aperture 152 and make contact with the underlying second elongate member 112. The stadium-shaped aperture 152 can be located between the elevated gripping element 150 and the wrap around portion 128 of the biasing member 122, can be centrally located along the width of the flat portion 124 and can have a length less than the length of the biasing member 122.

In one embodiment herein the plane of the flat portion 124 can be flush with the plane 132/126 of the underlying first or second elongate members 102/112, alternatively, the plane of the flat portion 124 can be such that it descends in a slight angle 156 in relation to the plane of the underlying elongate member 112 from an elevated gripping element end 158 towards the opposing end 160 of the flat portion 124, i.e., the portion contiguous the wrap-around portion 128 of the flat sliding longitudinal biasing member 122. The entire flat sliding longitudinal biasing member 122 can be moved along the elongate member 112, i.e., translated to the extent that the post 154 is able to be retained in the stadium shaped aperture 152 along the length thereof. Thus, the translation can be limited to the length of the aperture 152.

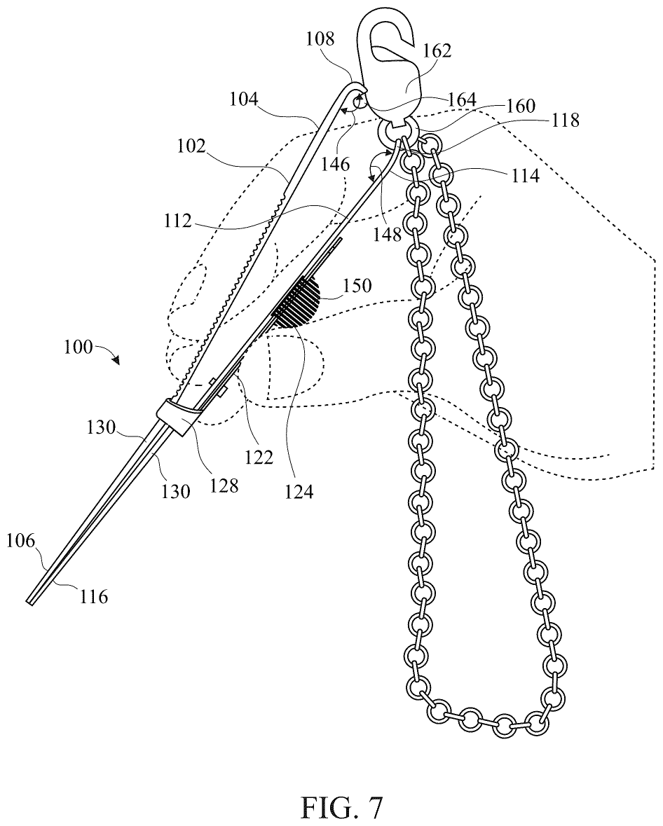

The encapsulation of the sides 130 by the wrap around portion 128 can make contact with the sides 130 of the first and second elongate members 102/112 and either partially or completely cover and/or make contact with the planar surface 132 of the opposing first elongate member 102 which is not covered by the flat portion 124. The contact made with the underlying elongate member 112 can impart a displacement of the elongate member 112 and the flat portion 124 of the flat sliding longitudinal biasing member 122 away from each other to a small amount, i.e., the slight angle 156, and this feature can contribute to and/or be enhanced in terms of biasing the elongate members 102/112 towards each other in the first 110 and second 120 directions by the longitudinal translation 134 movement of the biasing member 122 for the length of the aperture 150, wherein the movement of sliding biasing member 122 from the direction of the distal end 116 towards the proximal end 114 facilitates a biasing of the elongate members 102/112 together and vice-versa, a translation of the biasing member 122 from the direction of the proximal end 114 to the direction of the distal end 116 facilitates a biasing of the elongate members 102/112 away from each other. As shown in FIG. 7, the translation using the biasing member 122 can lock the biased distance of the elongate members 102/112 in such a position that a biasing pressure is not required to be kept in the opposing first and second directions by a user.

There is also provided a method of opening a jewelry fastener comprising providing a jewelry opening device 100 as described herein; and as shown in FIG. 4 attaching the obtusely angled forked tongue tip 118 on the proximal end 114 of the second flat elongate member 112 to a fixed position 160 on a lower end of a jewelry clasp 162; attaching the substantially perpendicularly angled tip 108 on the proximal end 104 of the first flat elongate member 102 to a lever 164 of the jewelry clasp 162; translating the flat sliding longitudinal biasing member 122 from the distal end 116 towards the proximal end 114 of the second flat elongate member 112 such that the first and second proximal ends 104/114 of the flat elongate members 102/112 are biased towards each other in the first 110 and second 120 directions to an extent that the lever 164 is depressed, as shown in FIG. 6, and the jewelry clasp 162 is opened.

In an alternative the device described herein can be opened by pushing the biasing component towards the proximal ends of the device. The device herein is such that the elongate members do not fit inside each other, and/or there is no spring involved in the biasing of the elongate members. When the elongate members are fully biased towards each other they can be such that they are not able to support a charm body therein in part or in whole. In the present invention, the device can be such that it can avoid touching a connecting component of a piece of jewelry and only be employed in contacting the fastener portion of the piece of jewelry. In another embodiment, the opening point of the device can be at the proximal ends of the device. In yet another embodiment the opening point of the device can be from 60% to 99%, preferably from 80% to 99% and most preferably from 90% to 99% of the holding point. The opening point of the device herein can be not small enough to split open a charm. The biasing component of the present device can be used to bias the elongate members together and not to keep them apart. The tips of the present invention can have an inwardly facing shape. The present device can be in the absence of wires, and in the absence of rigid wires. In one non-limiting embodiment, the device of the present invention can be longer than 1.6 inches, preferably greater than any one of 2 inches, 3 inches, 3.5 inches and 4 inches. The present device can be configured to open a fastener component by sliding and/or squeezing both elongate members towards each other and not by lifting one end relative to the other. The device of the present invention can be in the absence of a joint.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A jewelry opening device comprising:
a first flat elongate member having a proximal end and an opposing distal end, and a substantially perpendicularly angled tip on the proximal end of the first flat elongate member facing in a first direction;
a second flat elongate member having a proximal end and an opposing distal end, and an obtusely angled forked tongue tip on the proximal end of the second flat elongate member facing in substantially a second direction, which is substantially opposite to the first direction;
a flat sliding longitudinal biasing member which comprises:
a flat portion which lies in plane over a planar surface of the first or second flat elongate member between the proximal and distal end thereof, and
a wrap-around portion which extends perpendicularly from the flat portion and encapsulates sides of the first and second flat elongate members and at least part of the planar surface of an opposing first or second flat elongate member which is not overlaid by the flat portion, and
wherein the biasing member is configured to bias the first and second flat elongate members towards each other in the first and second directions as the flat sliding longitudinal biasing member translates longitudinally in a direction from the distal ends towards the proximal ends of the first and second elongate members, and configured to continuously keep at least part of both of the distal ends in flush contact along planar surfaces of the first and second elongate members which are not contacted by the biasing member.

2. The jewelry opening device of claim 1, wherein the first flat elongate member and the second flat elongate member are longitudinally and/or laterally aligned with each other.

3. The jewelry opening device of claim 1 wherein the first flat elongate member and the second flat elongate member each have a thickness of from 1/32 of an inch up to about 5/16 of an inch.

4. The jewelry opening device of claim 1, wherein the first and/or second flat elongate members have a grooved gripping area along at least portion of their planar surface.

5. The jewelry opening device of claim 1, wherein the first and/or second flat elongate members each have a length of from about 2 inches up to about 6 inches.

6. The jewelry opening device of claim 1, wherein the first and second elongate members have the same tapering widths from the distal end to a border of the tips of the proximal ends.

7. The jewelry opening device of claim 6, wherein the tapering width are from about ⅛ of an inch up to about h of an inch.

8. The jewelry opening device of claim 1, wherein the elongate members are made of a metal material selected from the group consisting of aluminum, steel, stainless steel, low carbon austenitic steel, chromium, nickel, molybdenum, and combinations thereof.

9. The jewelry opening device of claim 8, wherein the elongate members are made of low carbon austenitic steel which contains chromium and has nickel and molybdenum as additional alloying elements.

10. The jewelry opening device of claim 1, wherein the proximal and distal ends of the elongate members are opposite longitudinal ends thereof.

11. The jewelry opening device of claim 1, wherein the obtusely angled forked tongue tip can comprise an angle of greater than 90 degrees and less than 180 degrees,

12. The jewelry opening device of claim 1, wherein the obtusely angled forked tongue tip can comprise an angle of about 115 degrees to about 150 degrees.

13. The jewelry opening device of claim 1, wherein the first direction being substantially opposite the second direction comprises wherein the angle of the obtusely angled forked tip and the substantially perpendicularly angled tip are within a difference in degrees of no more than 45 degrees from each other, in terms of their respective angles.

14. The jewelry opening device of claim 1, wherein the first direction being substantially opposite the second direction comprises wherein the angle of the obtusely angled forked tip and the substantially perpendicularly angled tip are within a difference in degrees of no more than 5 degrees of each other.

15. The jewelry opening device of claim 1, wherein the thickness of the flat sliding longitudinal biasing member in both its flat portion and its wrap around portion are from 1/32 of an inch up to about 5/16 of an inch.

16. The jewelry opening device of claim 1, wherein the flat sliding longitudinal biasing member has a length less than that of the elongate members.

17. The jewelry opening device of claim 1, wherein the flat sliding longitudinal biasing member can further comprise an elevated gripping element on a planar surface of the flat portion.

18. The jewelry opening device of claim 17 wherein the elevated gripping element is made of an elastomeric material selected from the group consisting of natural rubber, synthetic rubber, ethylene rubber, ethylene propylene rubber, EPDM rubber, polyisoprene rubber, butyl rubber, acrylonitrile butadiene rubber, silicone rubber, polyurethane, cork, and combinations thereof.

19. The jewelry opening device of claim 1, wherein the flat sliding longitudinal biasing member has a stadium shaped aperture along the flat portion and a post which is oriented perpendicular to the flat portion of the flat sliding longitudinal biasing member, which post passes through the aperture and makes contact with the underlying elongate member.

20. A method of opening a jewelry fastener comprising:
providing a jewelry opening device comprising:
a first flat elongate member having a proximal end and an opposing distal end, and a substantially perpendicularly angled tip on the proximal end of the first flat elongate member facing in a first direction;
a second flat elongate member having a proximal end and an opposing distal end, and an obtusely angled forked tongue tip on the proximal end of the second flat elongate member facing in substantially a second direction, which is substantially opposite to the first direction;
a flat sliding longitudinal biasing member which comprises:
a flat portion which lies in plane over a planar surface of the first or second flat elongate member between the proximal and distal end thereof, and
a wrap-around portion which extends perpendicularly from the flat portion and encapsulates sides of the first and second flat elongate members and at least part of the planar surface of an opposing first or second flat elongate member which is not overlaid by the flat portion, and
wherein the biasing member is configured to bias the first and second flat elongate members towards each other in the first and second directions as the flat sliding longitudinal biasing member translates longitudinally in a direction from the distal ends towards the proximal ends of the first and second elongate members and configured to continuously keep at least part of both of the distal ends in flush contact along planar surfaces of the first and second elongate members which are not contacted by the biasing member;
attaching the obtusely angled forked tongue tip on the proximal end of the second flat elongate member to a fixed position on a lower end of a jewelry clasp;
attaching the substantially perpendicularly angled tip on the proximal end of the first flat elongate member to a lever of the jewelry clasp;
translating the flat sliding longitudinal biasing member from the distal ends to towards the proximal ends of the first and second flat elongate members such that the first and second proximal ends of the flat elongate members are biased towards each other in the first and second directions to an extent that when the lever is depressed the jewelry clasp is opened.
